(19) United States
(12) Patent Application Publication
(10) Pub. No.: US 2015/0353052 A1
(43) Pub. Date: Dec. 10, 2015

(54) DEFROSTER NOZZLE WITH NET OVER OUTLET

(71) Applicant: Ford Global Technologies, LLC, Dearborn, MI (US)

(72) Inventors: Fernando Cesar Salinas, Brighton, MI (US); Robert Steven Sawyer, Farmington Hills, MI (US)

(73) Assignee: Ford Global Technologies, LLC, Dearborn, MI (US)

(21) Appl. No.: 14/295,641

(22) Filed: Jun. 4, 2014

(51) Int. Cl. B60S 1/02; B60S 1/54; B23P 19/00

(52) U.S. Cl. CPC B60S 1/023; B23P 19/00; B60S 1/54

(57) ABSTRACT

A defroster nozzle assembly includes a nozzle body defining a conduit and an outlet in communication with the conduit and having a length and a width. A net of a polymeric material extends over the length and width of the outlet and is bonded directly to a portion of the nozzle body adjacent the outlet.

### FIELD OF THE INVENTION

The present invention generally relates to a cover for a defroster nozzle outlet. In particular, a polymeric net material is bonded directly to the defroster nozzle to cover the outlet therefrom.

### BACKGROUND OF THE INVENTION

Motor vehicle heating, ventilation, and air-conditioning (“HVAC”) systems are configured to direct air to various portions of an interior of an associated vehicle. Various outlets are positioned throughout a vehicle interior and are in communication with one or more air sources of the HVAC system. Such air sources can include an air conditioner, a heater, or an outside-air vent, and the HVAC system can further include respective fans or blowers associated with the individual air sources or a single system fan or blower to force air away from the source. A series of conduits, nozzles, or the like can facilitate the movement of air between the source and the outlets. Similarly, various baffles, diffusers, or the like can be included to allow air from one or more of the various sources to be directed to only certain ones of the outlets or to the various outlets at different rates.

Vehicle HVAC systems often include nozzles adapted to direct at least some air from one of the sources onto interior surfaces of windows of the vehicle. Commonly referred to as “defroster” nozzles, these structures are often at least included near a base of the vehicle windshield and are positioned within the dashboard to be aligned with corresponding apertures through the vehicle instrument panel. Such defroster nozzles are configured to direct a wide flow of air across the interior surface of the windshield and may extend generally across the entire dashboard over one or more associated apertures.

The positioning of defroster nozzles and the corresponding apertures along the dashboard makes them particularly susceptible to the ingress of objects, which can interfere with defroster operation or damage portions of the HVAC system. Accordingly, perforated covers of, for example, injection molded plastic have been included in a position between defroster nozzles and the associated instrument panel apertures. However, such covers are limited with respect to the ability to optimize a small opening size with minimal obstruction to air flow therethrough. For this and other reasons, improvements in defroster nozzle covers are desired.

### SUMMARY OF THE INVENTION

According to one aspect of the present invention, a defroster nozzle assembly includes a nozzle body defining a conduit and an outlet in communication with the conduit and having a length and a width. A net of a polymeric material extends over the length and width of the outlet and is bonded directly to a portion of the nozzle body adjacent the outlet.

According to another aspect of the present invention, a vehicle instrument panel includes a substrate having an interior, an exterior, and an aperture between the interior and the upper surface. The instrument panel further includes a nozzle positioned adjacent the interior of the substrate and defining a conduit and an outlet in communication with the conduit and aligned with the aperture. A polymeric net is positioned between the defroster nozzle and the substrate interior, is bonded directly to a portion of the defroster nozzle, and extends within the aperture.

According to another aspect of the present invention, a method for making a defroster nozzle assembly includes cutting a first net section from a bulk net supply, the net section being dimensioned to cover a first outlet in a nozzle body and to extend outwardly beyond the first outlet. The method further includes directly bonding a portion of the first net section extending outwardly beyond the first outlet to a portion of the nozzle body adjacent the first outlet.

### BRIEF DESCRIPTION OF THE DRAWINGS

In the drawings:

FIG. 1 is an overhead view of a defroster nozzle assembly according to an embodiment;

FIG. 2 is a partial perspective view of a motor vehicle having an HVAC system including a defroster nozzle assembly according to FIG. 1;

FIG. 3 is a detailed view of a portion of the defroster nozzle assembly of FIG. 1;

FIG. 4 is a perspective view of an alternative portion of a defroster nozzle assembly;

FIG. 5 is a perspective view of a further alternative portion of a defroster nozzle assembly; and

FIG. 6 is a perspective view of a defroster nozzle assembly with a related art perforated cover assembled therewith.

### DETAILED DESCRIPTION OF THE PREFERRED EMBODIMENTS

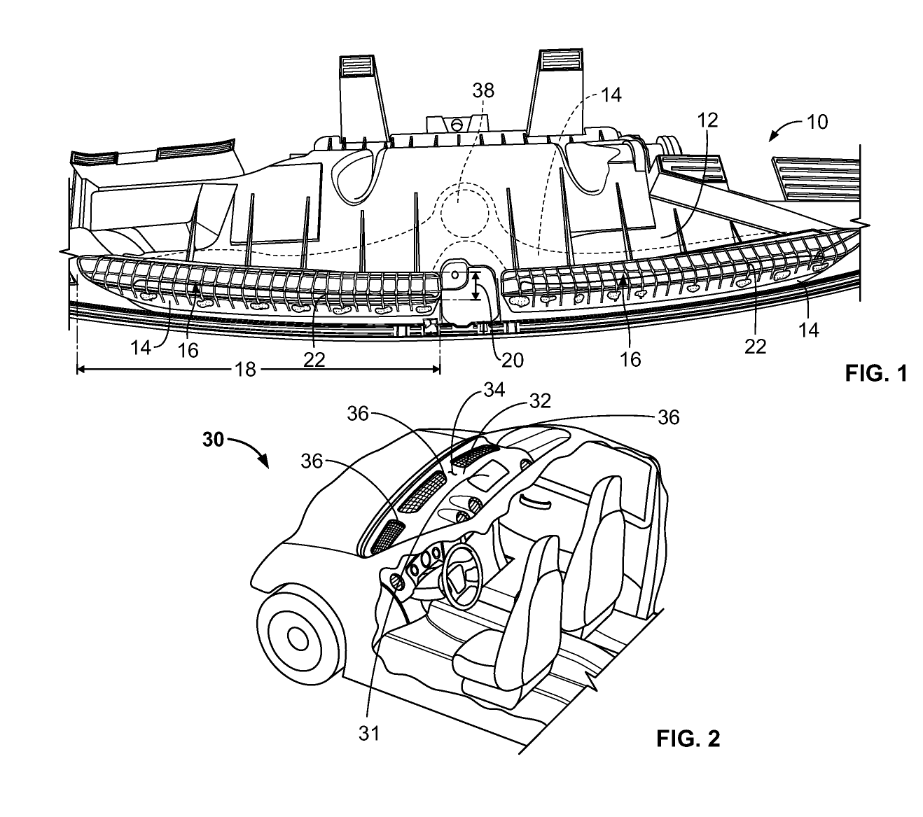

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to the Figures, where like reference numerals indicate like features, FIG. 1 shows a defroster nozzle assembly 10 that includes a nozzle body 12. Nozzle body 12 defines a conduit 14 and an outlet 16 in communication with the conduit 14. The outlet 16 extends in lateral directions including a length 18 and a width 20, which can vary according to the particular application of conduit 14, such as in various examples herein. A net 22 of a polymeric material, which in an embodiment may be polypropylene or the like, extends over the length 18 and the width 20 of the outlet 16, and is bonded directly to a portion, for example an outside surface 50, of conduit 14. The direct bonding of net 22 to nozzle body 12 may be achieved by any method of attaching the net 22 to the nozzle body 12, which may include plastic welding (including spot or stake welding) ultrasonic (or other types of vibration) welding, infrared welding, gluing, or the like. In general, net 22 may be made up of a plurality of polymeric filaments 24, which can be arranged to collectively define a plurality of openings 26 arranged in a geometric pattern, the filaments 24 and openings 26 being such that air flow out of outlet 16 is permitted, while the entry of certain objects into conduit 14 through outlet 16 is restricted.

As shown in FIG. 2, various defroster nozzle assemblies 10, as presently described, an example of which being as shown in FIG. 1 and including a net 22 in assembly therewith, can be a part of an HVAC system of a motor vehicle 30. An example of a defroster nozzle assembly 10 is shown in a position along an upper surface 34 of an instrument panel 32 of the vehicle 30. Instrument panel 32 extends in lateral directions (i.e. from side-to-side and front-to-back with respect to vehicle 30) and defines a surface that is referred to herein as being generally planar, although the surface may curve along one or both of the lateral directions in various portion of instrument panel 32. In the example of FIG. 2, defroster nozzle assembly 10 is configured as a windshield defroster nozzle assembly 10 and may be usable in connection with the HVAC system (the remainder of which is internal to vehicle 30 and is not shown in FIG. 2) to direct a stream of air onto an interior surface of windshield 31 to help prevent or remove condensation thereon. In such a location, defroster nozzle assembly 10 can be positioned such that an appropriately-configured variation of outlet 16, or a plurality of outlets 16, align with defroster apertures 36 in instrument panel 32, which are in a position adjacent windshield 31. Defroster nozzle assembly 10 may be configured so as to apply a generally even flow of air onto the interior surface of windshield 31.

Accordingly, it may be useful to maximize an open area of outlet 16 that is not obstructed by the filaments 24 of net 22. Conversely, the location of apertures 36, and accordingly outlets 16, on the upper surface 34 of instrument panel 32 makes outlets 16 particularly susceptible to the entry of foreign objects. Similarly, the resulting vertical orientation of conduits 14 in the areas adjacent outlets 16 would make any such foreign objects difficult to retrieve from nozzle body 12 before they would potentially proceed into further portions of the HVAC system in which they would become lodged within nozzle body 12 or other portions of the vehicle HVAC system, thereby obstructing the flow of air through conduit 14 and out of outlets 16. The positioning and configuration of nets 22 over outlets 16, as described herein, may help mitigate such problems by blocking many foreign objects, particularly those of a size that may be damaging or otherwise problematic, from entering nozzle body 12.

An example of a vehicle HVAC system with which defroster nozzle assembly 10 can be associated may include an air source or a plurality of air sources positioned within a portion of vehicle 30, such as within the engine compartment or the like. The air source (not shown) may include a heater, an air conditioning unit, or a combination of heater and air conditioner. The air source may be connected with a series of conduits, dampers, valves, baffles, or the like which may serve to direct the flow of air from the air source throughout portions of interior vehicle 30. Some of these components may be moveable and may be controlled by the user through a series of switches on the instrument panel 32, for example, or may be automatically controlled by a dedicated control system within vehicle 30. Accordingly, defroster functionality can be achieved by a passenger of vehicle 30 or a control system within vehicle 30 configuring components of the HVAC system to direct all or a portion of the air provided by the air source through selected ones of the various conduits 14 and into an inlet 38 of nozzle body 12, as illustrated in FIG. 1.

Accordingly, a defroster nozzle assembly 10, such as the one shown in the example of

FIG. 1, and net 22 extending over outlet 16, or outlets 16, may be particularly suited for use in the location of a windshield defroster, as shown in FIG. 2, due to the ability of net 22 to provide for a pattern of openings 26 having sizes small enough to prevent potentially problematic objects from passing through outlets 16, while allowing a relatively high percentage of outlet 16 to remain unobstructed by filaments 24, such that the airflow through conduits 14 and out of outlet 16 is not negatively impacted by the presence of nets 22.

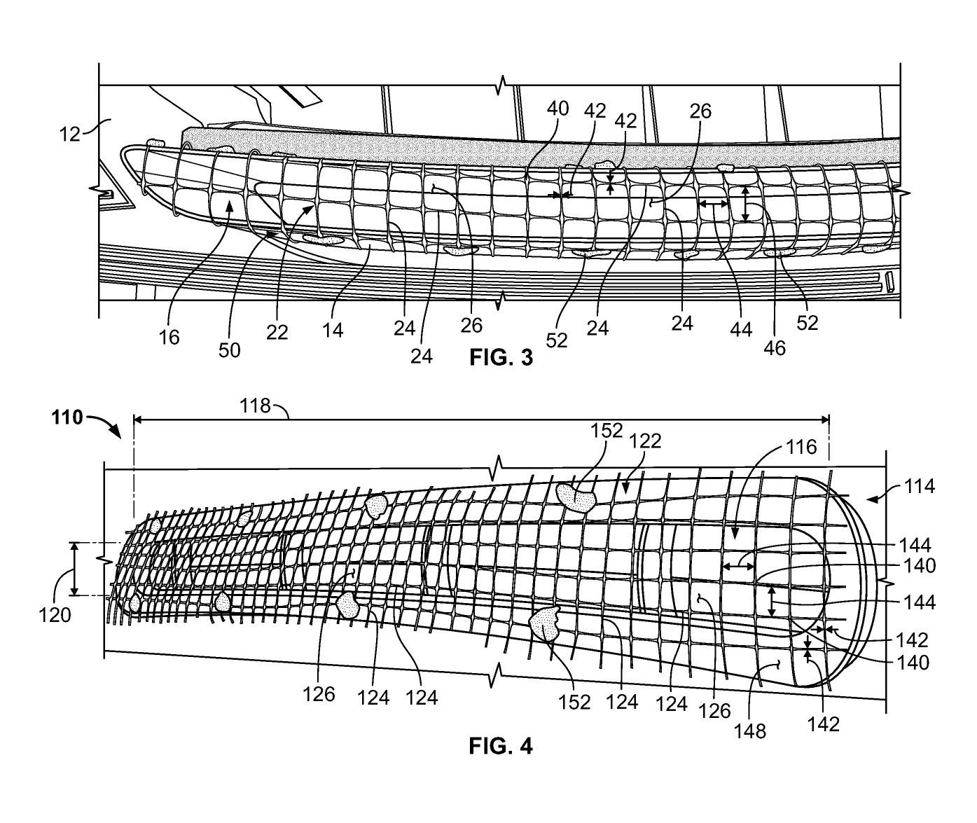

Certain properties of the material used for nets 22, discussed with reference to FIG. 3, may make the defroster nozzle assembly 10 shown herein particularly well-suited for use in connection with a defroster aperture 36, as described above. In particular, net 22 may be of a plurality of filaments 24 arranged to extend in various directions according to a particular pattern in which intersections 40 result from respective ones of the various filaments 24 crossing each other within the framework of the pattern. The various filaments 24 may be fused or otherwise joined together at intersections 40 to help maintain the relative positioning of filaments 24. In such a configuration, wherein a plurality of filaments 24 extend in multiple, respective directions, each of the filaments 24 extending in one direction may intersect with a number of other filaments 24 extending in at least one other direction. Accordingly net 22 is structured so as to be self-supporting, meaning that net 22 is capable of maintaining the desired geometric configuration based solely on the bonding at intersections 40 between crossing filaments 24, without the need for a frame or other additional supporting element. This structure allows net 22 to be directly bonded to nozzle body 12, as described above, such as by using bond points 52 of plastic or another polymeric material. In the example shown, bond points 52 extend over portions of one or more of the filaments 24 and bond with an adjacent portion of nozzle body 12.

The above-described configuration of net 22, in which a plurality of filaments 24 are arranged to cross over one another and are bonded at the intersections 40 formed by such crossing, is such that net 22 can be a section cut from a larger piece of bulk net (not shown) configured with filaments of the desired size for filaments 24 arranged in the desired pattern. Accordingly net 22 can be fabricated by cutting an individual section of bulk net, that section being sufficient to extend over both the width 20 and the length 18 of outlet 16, as well as to extend outwardly in at least one lateral direction beyond outlet 16 to allow room for the above-described direct bonding of net 22 to nozzle body 12. In the example shown in FIG. 1, net 22 may be sized so that the portions thereof that extend outwardly beyond outlet 16 can be bent or otherwise deformed downwardly and into contact with portions of outside face 50 of conduit 14. In such a configuration, the bond points 52 that directly bond net 22 to nozzle body 12 can be deposited or otherwise formed over net 22 on portions of selected ones of filaments 24 adjacent outside face 50 so as to bond to filaments 24 to the underlying portion of outside face 50 of nozzle body 12. Multiple spot welds can be used as needed, to achieve a desired retention of net 22 to nozzle body 12. In the example shown in FIG. 3, bond points 52 are shown spaced apart at varying intervals around the circumference of outlet 16 to couple net 22 to nozzle body 12, as well as to ensure that net 22 is deformed into a shape that generally conforms to that of outlet 16. It is further noted that the same, or similar, piece of bulk net can be used to make multiple nets 22, as shown in FIG. 3 for example, such nets 22 being intended to be associated with differently-shaped outlets 16. Multiple nets 22 can be fabricated and assembled with a nozzle body 12 by, for example, cutting a section of the bulk net to fit over each of the desired outlets 16 and by affixing the cut nets 22 over the corresponding outlet 16 and by bonding excess portions of the nets 22 to the nozzle body 12 in respective areas of outlet 16. Optionally, excess portions of net 22 beyond the area necessary to form bond points 52 can be trimmed off

In the examples shown in FIGS. 1 and 3, net 22 is shown having filaments 24 arranged in a rectangular grid pattern. In particular, net 22 according to such an example includes a plurality of generally parallel filaments 24 extending in a first lateral direction, and a second set of filaments 24 extending in the direction perpendicular to the first direction. The respective sets of filaments 24 are spaced apart at regular intervals such that filaments 24 define a grid with a plurality of rectangular openings 26 separated by the filaments 24. The openings 26 are bounded by portions of segments of filaments 24 along the sides thereof and have filament intersections 40 defining the corners thereof. It is noted that other arrangements of filaments are possible and can result in nets having other various geometric patterns, for example the first and second sets of filaments 24 can extend relative to each other in a non-perpendicular angle such that the associated net defines openings thereof generally in a parallelogram, diamond, or similar shape. In another example, three of more sets of filaments 24 can be included and can extend in respective different directions to form a net having a plurality of openings having uniform or non-uniform shapes that can include combinations of squares, hexagons, octagons, triangles, or the like. Other types of geometric arrangements are possible, and can be achieved, for example, by braiding, weaving, or other techniques to achieve a pattern in which filaments do not extend in a linear arrangement. In yet another example, a net of a desired pattern may be formed by cutting openings in a sheet of polymeric material with the various sections of the polymeric material remaining and surrounding the openings being considered the filaments of the net.

Returning to the example of FIG. 3, openings 26 define a width 44 and depth 46 over generally uniform open areas. In the example shown, openings 26 are configured such that width 44 is substantially equal to depth 46, resulting in openings 26 that are generally square in shape, variations therein resulting from an increased filament width at intersections 40 due to the bond formation thereat. As mentioned above, other configurations are possible, for example, width 44 and depth 46 can be different so as to result in rectangular openings 26 extending in either the direction of width 44 or depth 46. In any configuration, net 22 may be considered as defining an overall open area based on an aggregate value of the combined areas of the individual openings 26, or portions thereof, which overlie outlet 16. Similarly, net 22 can be considered as defining an overall obstructed area, which may be the aggregate area of filaments 24 that extend over outlet 16. Accordingly, a ratio of open area to obstructed area within a net 22, or a portion thereof overlying outlet 16, may depend on both the width 44 and depth 46 of the openings, as well as the width 42 (or diameter) of the filaments 24.

In an embodiment, net 22 may be configured such that the ratio of open area to obstructed area is at least 7:3 or such that no less than 70% of the total area of outlet 16 is open. In another embodiment, filaments 24 of net 22 can be spaced apart to bound openings 26 having substantially equal areas of between about 38 mm² and about 170 mm². Further, net 22 can be made up of filaments 24 having substantially equal diameters, measured in portions thereof spaced equally between adjacent intersections 40, of between about 0.15 mm and about 0.5 mm. In another embodiment, filaments 24 can have substantially equal diameters 42 of less than about 2 mm, or, in another embodiment, of less than about 1.5 mm. Other variations of nets, such as those described above, can be configured having openings with areas in the same or similar ranges, as well as with filaments having diameters in the same or similar ranges such as described above with respect to FIG. 3. Still further, various other nets, with other geometric patterns for example, can be configured having a ratio of open area to obstructed area similar to that described above with respect to FIG. 3.

FIG. 4 shows another assembly of a net 122 with a conduit 114 that can be a part of a nozzle assembly similar to that which is shown in FIG. 1. In this example, conduit 114 includes a face 148 which extends laterally outward from outlet 116 to which net 122 can be directly bonded, such as by bond points 152, or the like. Net 122 can be of a similar construction to that which was described above with respect to FIG. 3, and can further be cut from a bulk net material in a similar manner to that which was also described above with respect to FIG. 3. In such a construction, an allowance for a cut bulk net portion defining net 22 can extend sufficiently to cover both the width 118 and the depth 120 of outlet 16, with further material extending outwardly so as to overlie at least a portion of face 148. Net 122 can further be aligned with conduit 114, and in particular, with face 148 to allow bonding similar to that which was described above with respect to FIG. 3, but without the need to bend or otherwise deform net 122 against a side (e.g. outside surface 50). FIG. 4 also shows an assembly 110 including a net 122 having openings 126 bounded by respective sections of adjacent filaments 124 bonded at joints 140 therebetween. The openings 126 can define areas that may be smaller than openings 26 illustrated in FIG. 3. For example, net 22 in FIG. 3 may be considered as defining openings 26 with an area of about 170 mm², while net 122 illustrated in FIG. 4 may include openings 126 having respective areas of about 38 mm². Such comparative examples of opening areas are intended merely for illustration and may depend on the relative scales of the respective openings shown in the Figures, which may not be reflected therein.

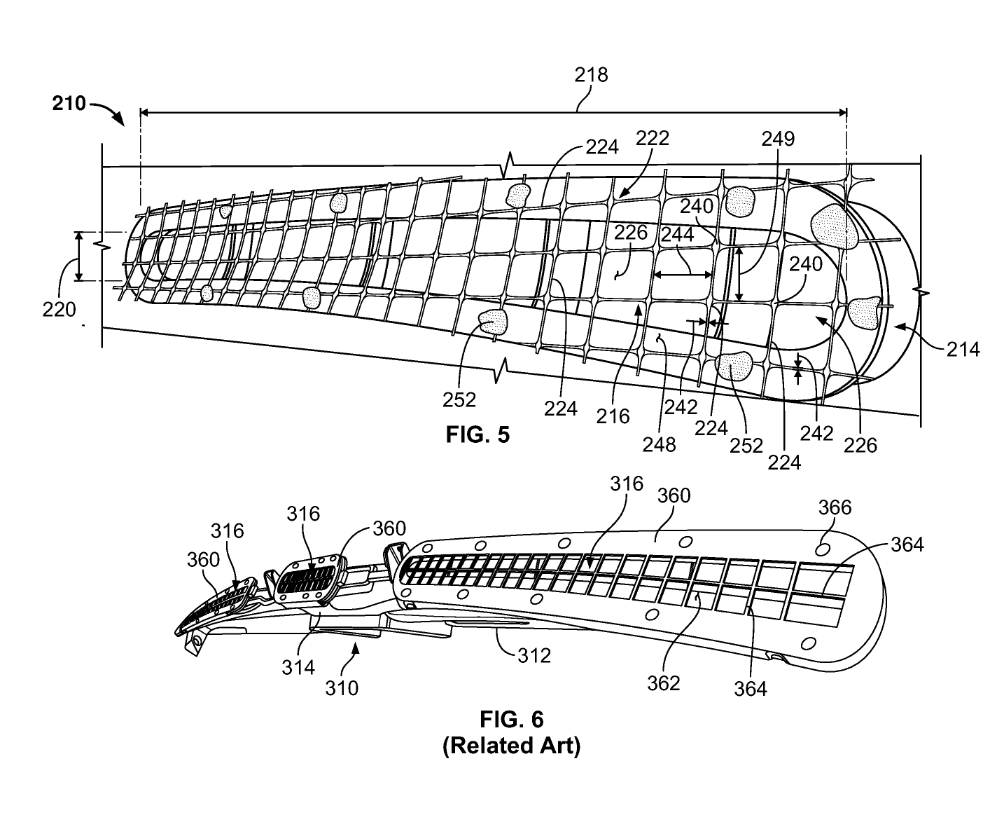

FIG. 5 depicts a further example of an assembly 210 of a net 220 with a conduit 214, which is similar to that depicted in FIG. 4. In the example of FIG. 5, net 222 may include openings 226 surrounded by respective adjacent sections of filaments 224 bonded together at joints 240 so as to define areas larger than that of net 122 depicted in FIG. 4. The illustrations of similar conduits 114 and 214 both having outwardly-extending faces 148 and 248 surrounding respective outlets 116 and 216 shows how the use of a net of the type described herein can be adapted for use in connection with a nozzle assembly, such as nozzle assembly 10 shown in FIG. 1 or other variations thereof, in a similar manner within numerous variations of the net itself. For example, several variations of net material can be used with various types of nozzle bodies, so long as the stock net material meets the desired criteria for use in connection with, for example, a defroster aperture in a vehicle, such as defroster apertures 36 within vehicle 30 as depicted in FIG. 2. Such criteria can include the ratio of open area to obstructed area, as discussed above, and can further include requirements for the tensile strength of the filaments 24 that comprise net 22. For such use the selected bulk net material can be cut to the desired size and secured in place using spot welds (52, 152, or 252, for example) to secure the net in place.

The above-described use of a polymeric net material for a defroster outlet and corresponding assembly, as described herein, present various advantages over related perforated covers 360, an example of which is illustrated in FIG. 6 in assembly with a nozzle body 312. In the related art example of FIG. 6, for instance various different covers 360, which are formed of an injection molded plastic material, are specifically designed for an outlet 316 (including the particular size and shape) that they are intended to cover. Further, the use of injection molding to form covers 360 can result in segments 364 that have a tensile strength lower than that of the filaments (24, 124, and 224, for example) associated with the various embodiments of nets 22, 122, and 222 described above. Accordingly, these segments 364 defining the obstructed area of covers 360 may generally be thicker than the filaments 24, 124, and 224 described herein. This means that the use of a polymeric net 22, 122, or 222 may result in a structure with the ability to meet or exceed standards for open area to obstructed area ratios for defroster outlets with smaller outlet sizes than would be possible with an injection molded cover 360 of the related art shown in FIG. 6. This may result in assemblies which are not only easier and more cost-effective to achieve, but also defroster outlet covers that are less susceptible to accidental ingress of foreign objects, as described above. In other examples, a separate grill (not shown) can be positioned over nozzle outlet 16 and further over net 22 within aperture 36 to provide a finished appearance for aperture 36 and to appropriately direct the flow of air therethrough. Because net 22 is present to prevent the ingress of objects into nozzle body 12, for example, such a grill does not have to meet any requirements for object ingress prevention and, thus, can be of a design that is free to focus more on air direction and appearance.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

We claim:

1. A defroster nozzle assembly, comprising:
a nozzle body defining a conduit and an outlet in communication with the conduit and having a length and a width; and
a net of a polymeric material extending over the length and the width of the outlet and bonded directly to a portion of the nozzle body adjacent the outlet.

2. The defroster nozzle assembly of claim 1, wherein the net is of a plurality of bonded polymeric filaments.

3. The defroster nozzle assembly of claim 1, wherein the polymeric material comprises polypropylene.

4. The defroster nozzle assembly of claim 1, wherein the net includes a plurality of filaments having a diameter of less than 1.5 mm.

5. The defroster nozzle assembly of claim 4, wherein the filaments are spaced apart to define open areas therebetween, the open areas having substantially equal areas of between about 38 mm² and about 170 mm².

6. The defroster nozzle assembly of claim 1, wherein the outlet defines an open area, and wherein the net includes a plurality of filaments overlying the open area such that the net defines an obstructed area within the open area, the open area and the obstructed area defining a ratio of at least 7:3.

7. The defroster nozzle assembly of claim 1, wherein the nozzle body defines a face surface extending outwardly from and surrounding the outlet, the net being bonded directly with the nozzle body on the face surface thereof.

8. The defroster nozzle assembly of claim 1, wherein the nozzle body defines an outside conduit surface along an exterior thereof, and wherein the net is bonded directly with the nozzle body on the outer conduit surface thereof.

9. The defroster nozzle assembly of claim 1, wherein the net is bonded directly to a portion of the nozzle body by plastic spot welding.

10. A vehicle instrument panel, comprising:
a substrate having an interior, an exterior, and an aperture between the interior and the exterior;
a nozzle positioned adjacent the interior of the substrate and defining a conduit and an outlet in communication with the conduit and aligned with the aperture; and
a polymeric net between the defroster nozzle and the substrate interior, bonded directly to a portion of the defroster nozzle, and extending within the aperture.

11. The vehicle instrument panel of claim 10, wherein the polymeric net includes a plurality of polymeric filaments bonded together in a geometric pattern.

12. The vehicle instrument panel of claim 11, wherein the geometric pattern is a rectangular grid pattern.

13. The vehicle instrument panel of claim 12, wherein the rectangular grid pattern defines openings surrounded by adjacent segments of ones of the plurality of polymeric filaments, the openings having substantially equal widths of between ¼ inch and ½ inch and substantially equal lengths of between ¼ inch and ½ inch.

14. The vehicle instrument panel of claim 13, wherein the geometric pattern defines a plurality of open areas, each surrounded a plurality of adjacent segments of ones of the plurality of polymeric filaments, the segments separating the open areas and defining obstructed areas therebetween, the open areas and obstructed areas of the net having a ratio of at least 7:3.

15. The vehicle instrument panel of claim 11, wherein:
the substrate extends in first and second directions generally along a plane; and
the polymeric net extends within the aperture along the first and second directions so as to partially obstruct the aperture.

16. A method for making a defroster nozzle assembly, comprising:
cutting a first net section from a bulk net supply, the net section being dimensioned to cover a first outlet in a nozzle body and to extend outwardly beyond the first outlet; and
directly bonding a portion of the first net section extending outwardly beyond the first outlet to a portion of the nozzle body adjacent the first outlet.

17. The method of claim 16, wherein the nozzle body defines an outside conduit surface along an exterior thereof and surrounding the first outlet, the step of directly bonding a portion of the first net section to a portion of the nozzle body includes directly bonding a portion of the first net section to a portion of the outer conduit surface.

18. The method of claim 17, further including, prior to the step of directly bonding, deforming the first net section such that the portion of the first net section extending outwardly beyond the outlet contacts a portion of the outside conduit surface.

19. The method of claim 16, wherein the nozzle body defines a face surface extending outwardly from and surrounding the first outlet, the step of directly bonding a portion of the first net section to a portion of the nozzle body including directly bonding a portion of the first net section to the face surface.

20. The method of claim 19, further including:
cutting a second net section from the bulk net supply, the second net section being dimensioned to cover a second outlet in the nozzle body and to extend outwardly beyond the second outlet; and
directly bonding a portion of the second net section extending outwardly beyond the first outlet to a portion of the nozzle body adjacent the second outlet.
